(19) United States
(12) Patent Application Publication
(10) Pub. No.: US 2016/0021457 A1
(43) Pub. Date: Jan. 21, 2016

(54) AUTOMATIC AUDIO-PATH DETERMINATION FOR A PERIPHERAL SPEAKER

(71) Applicant: MOTOROLA MOBILITY LLC, Chicago, IL (US)

(72) Inventors: Roland S. Labana, Bloomingdale, IL (US); Matthieu R. Crepeau, Chicago, IL (US); Kevin J. McDunn, Lake In The Hills, IL (US); Rohit R. Sinha, Grayslake, IL (US); LieJun Tao, Naperville, IL (US); Gerald E. Corrigan, Chicago, IL (US)

(21) Appl. No.: 14/336,096

(22) Filed: Jul. 21, 2014

(51) Int. Cl. H04R 3/12; H04R 27/00

(52) U.S. Cl. CPC H04R 3/12; H04R 27/00; H04R 2499/13; H04R 2420/07

(57) ABSTRACT

Disclosed are techniques to automatically determine an audio path for a peripheral speaker. A wireless device uses particular wireless-communication methods or techniques, referred to as an audio path, to wirelessly communicate audio data to a speaker system for playback by a peripheral speaker. The device selects an audio path and attempts to send audio data representing known audio to the speaker system using the selected audio path. If a microphone of the device receives the known audio, then the device determines that the selected audio path is supported by the speaker system and thus can be used to communicate audio data to the peripheral speaker. However, if the microphone does not receive the known audio, then the device repeats the selecting of an audio path and attempting to send audio data to the speaker system using the newly selected audio path.

### TECHNICAL FIELD

The present disclosure is related generally to playing back audio and, more particularly, to automatically determining an audio path for a peripheral speaker.

### BACKGROUND

As computing technology has advanced, the types of computing devices available and the functionality they provide have increased. This has led to a desire on the part of users to use their devices in various different settings and oftentimes in conjunction with other devices. While this device usage has many benefits to the user, it is not without its problems. One such problem is that it can be difficult for users to get their computing devices to work properly with other devices. This results in user frustration and dissatisfaction with their computing devices.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 illustrates an example environment in which an audio path for a peripheral speaker can be automatically determined in accordance with one or more embodiments;

FIG. 2 illustrates an example system implementing the techniques discussed herein;

FIG. 3 is a flowchart of an exemplary process for automatically determining an audio path for a peripheral speaker in accordance with one or more embodiments; and

FIG. 4 is a schematic illustrating various components of an example electronic device that can implement the techniques discussed herein.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

Automatic determination of an audio path for a peripheral speaker is discussed herein. A wireless device uses an audio path to communicate to a peripheral speaker of a speaker system audio data that are to be played back by the peripheral speaker. The audio path refers to the wireless-communication methods or techniques used by the wireless device to wirelessly communicate audio data to the speaker system for playback. The audio path can include use of a particular wireless-communication technology (e.g., Bluetooth or Wi-Fi), use of a particular method supported by the wireless-communication technology, and so forth. Various different audio paths are supported by the wireless device, and the wireless device need not have prior knowledge of or be configured to know which of those one or more audio paths (if any) are supported by the speaker system.

Using the techniques discussed herein, the audio path for the wireless device to use to communicate audio data to a particular speaker system is automatically determined. The wireless device selects one of the audio paths that the wireless device supports and attempts to send audio data to the speaker system using the selected audio path. The audio data are representative of audio to be played back by the peripheral speaker, such as a particular tone, a spoken word or phrase, and so forth. The wireless device includes a microphone that the wireless device uses to listen for the audio. If the wireless device receives the audio, then the wireless device determines that the selected audio path used to send the audio data to the speaker system is supported by the speaker system and thus can be used to communicate audio data to the speaker system. However, if the wireless device does not receive the audio, then the wireless device determines that the selected audio path used to send the audio data to the speaker system is not supported by the speaker system, and the wireless device repeats the process by selecting a different audio path and attempting to send audio data to the speaker system using the selected audio path.

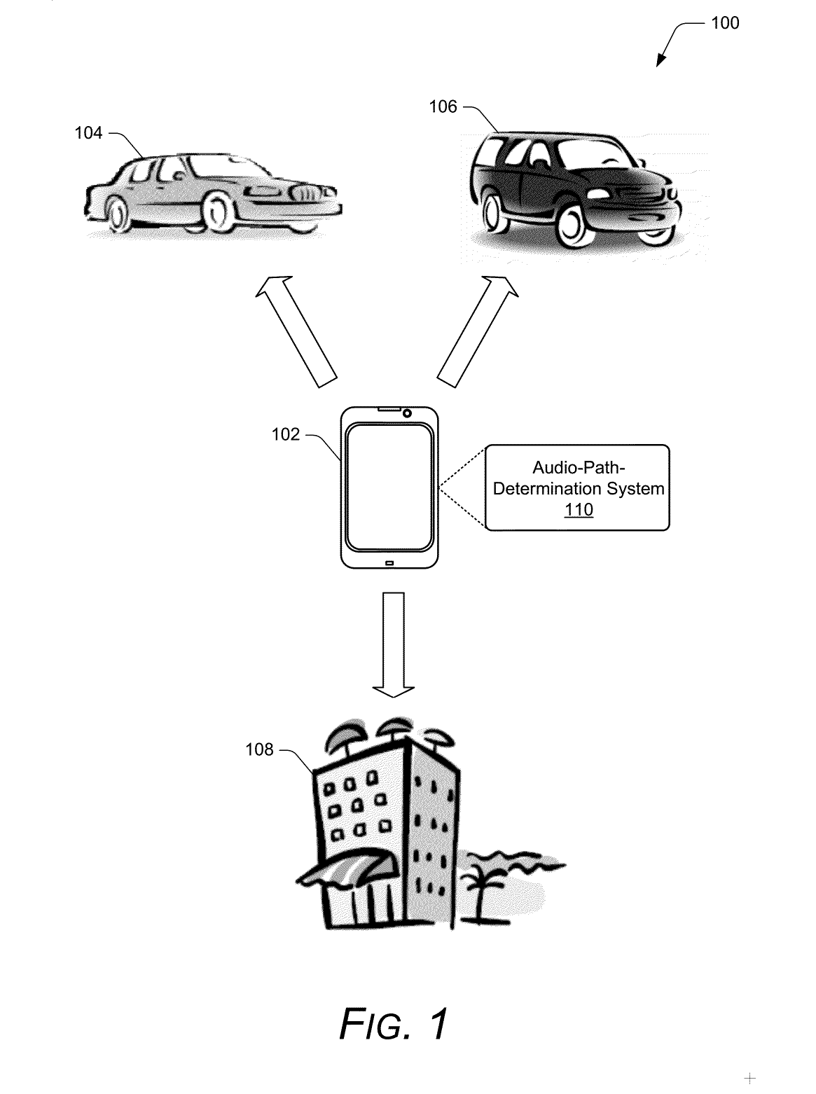

FIG. 1 illustrates an example environment 100 in which an audio path for a peripheral speaker can be automatically determined in accordance with one or more embodiments. The environment 100 includes a wireless device 102, two vehicles 104 and 106, and a building 108. The wireless device 102 can be a mobile device such as a cellular or other wireless phone (e.g., a smartphone), a tablet, a phablet, an audio/video playback device, and so forth. The vehicle 104 is illustrated as a car and the vehicle 106 is illustrated as a truck, but the vehicles 104 and 106 can be any of a variety of different vehicles that may be driven by a user such as a car, truck, motorcycle, boat, plane or other aircraft, train or other vehicle driven on a track or rails, and so forth. The building 108 can be any of a variety of buildings, such as an apartment building, hotel, office building, and so forth.

The wireless device 102 includes an audio-path-determination system 110. When the wireless device 102 is located in the vehicle 104, the audio-path-determination system 110 automatically determines an audio path to use to allow the wireless device 102 to play back audio data using a speaker included in the vehicle 104. Similarly, when the wireless device 102 is located in the vehicle 106, the audio-path-determination system 110 automatically determines an audio path to use to allow the wireless device 102 to play back audio data using a speaker included in the vehicle 106. And, when the wireless device 102 is located in the building 108, the audio-path-determination system 110 automatically determines an audio path to use to allow the wireless device 102 to play back audio data using a speaker included in the building 108. Thus, a user can take the wireless device 102 to various different ones of vehicle 104, vehicle 106, and building 108, and the wireless device 102 automatically determines the correct audio path to use to play back audio given the one of the vehicle 104, vehicle 106, and building 108 in which the wireless device 102 is currently situated.

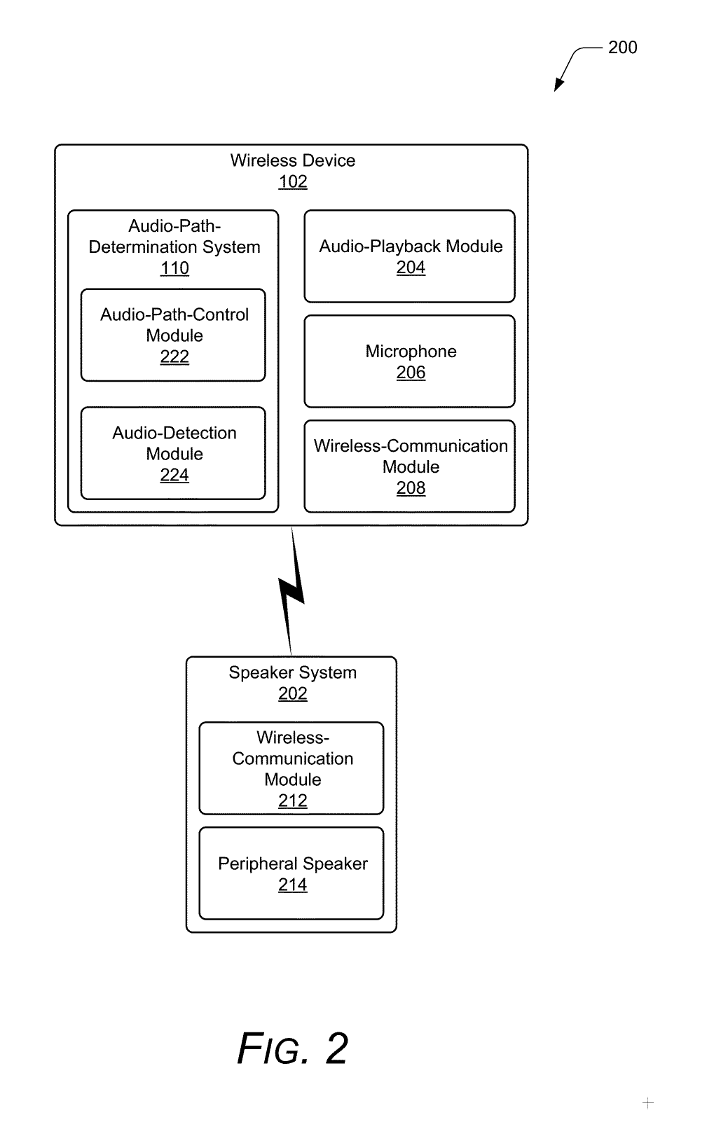

FIG. 2 illustrates an example system 200 implementing the techniques discussed herein. The system 200 includes wireless device 102 and a speaker system 202. The wireless device 102 and the speaker system 202 are implemented as distinct devices. For example, the speaker system 202 can be a vehicle kit and vehicle speaker, the vehicle kit receiving audio data from the wireless device 102 and playing back the audio represented by the audio data using the vehicle speaker. By way of another example, the speaker system 202 can be one or more devices in a hotel room or office that receive audio data from the wireless device 102 and play back the audio represented by the audio data using the speaker in the hotel room or office.

The wireless device 102 includes the audio-path-determination system 110, an audio-playback module 204, a microphone 206, and a wireless-communication module 208. The audio-path-determination system 110 automatically determines an audio path for the wireless device 102 to use to allow the wireless device 102 to play back audio data using the speaker system 202. The audio-path-determination system 110 notifies the wireless-communication module 208 of the audio path to use to send audio data to the speaker system 202. The audio data to be sent to the speaker system 202 are received by the wireless-communication module 208 from the audio-playback module 204. The audio data can be audio data used by the audio-path-determination system 110 in determining the audio path to use to play back audio data using the speaker system 202 or other audio data intended for playback by the speaker system 202 such as music, movie audio, voices of people on a phone call, text message or email message transcriptions, and so forth.

The speaker system 202 includes a wireless-communication module 212 and a peripheral speaker 214. The peripheral speaker 214 is a device that produces sound (sound waves) in response to received audio data. The wireless-communication module 212 and the peripheral speaker 214 can be implemented in the same housing or alternatively in separate housings. For example, the wireless-communication module 212 can be implemented as part of a receiver component that is separate from, but coupled to, a peripheral speaker 214 in a car. By way of another example, the wireless-communication module 212 and the peripheral speaker 214 can both be implemented as part of a speaker or television housing in a hotel room, office, apartment, and so forth.

The audio-path-determination system 110 includes an audio-path-control module 222 and an audio-detection module 224. The audio-path-control module 222 determines which of multiple audio paths to use to communicate with the speaker system 202. The audio-detection module 224 facilitates the determination of the audio path to use by determining whether the expected audio is received by the microphone 206 as discussed in more detail below.

Although particular functionality is discussed herein with reference to particular systems and modules, it should be noted that the functionality of individual systems or modules can be separated into multiple systems or modules. It should also be noted that at least some functionality of multiple systems or modules can be combined into a single system or module. Additionally, a particular system or module discussed herein as performing an action includes that particular system or module itself performing the action or alternatively that particular system or module invoking or otherwise accessing another component, system, or module that performs the action (or performs the action in conjunction with that particular system or module). Thus, discussion of a particular system 110, 202 or module 204, 208, 212, 222, 224 performing an action includes that particular system 110, 202 or module 204, 208, 212, 222, 224 itself performing the action or another system or module invoked or otherwise accessed by that system 110, 202 or module 204, 208, 212, 222, 224 performing the action.

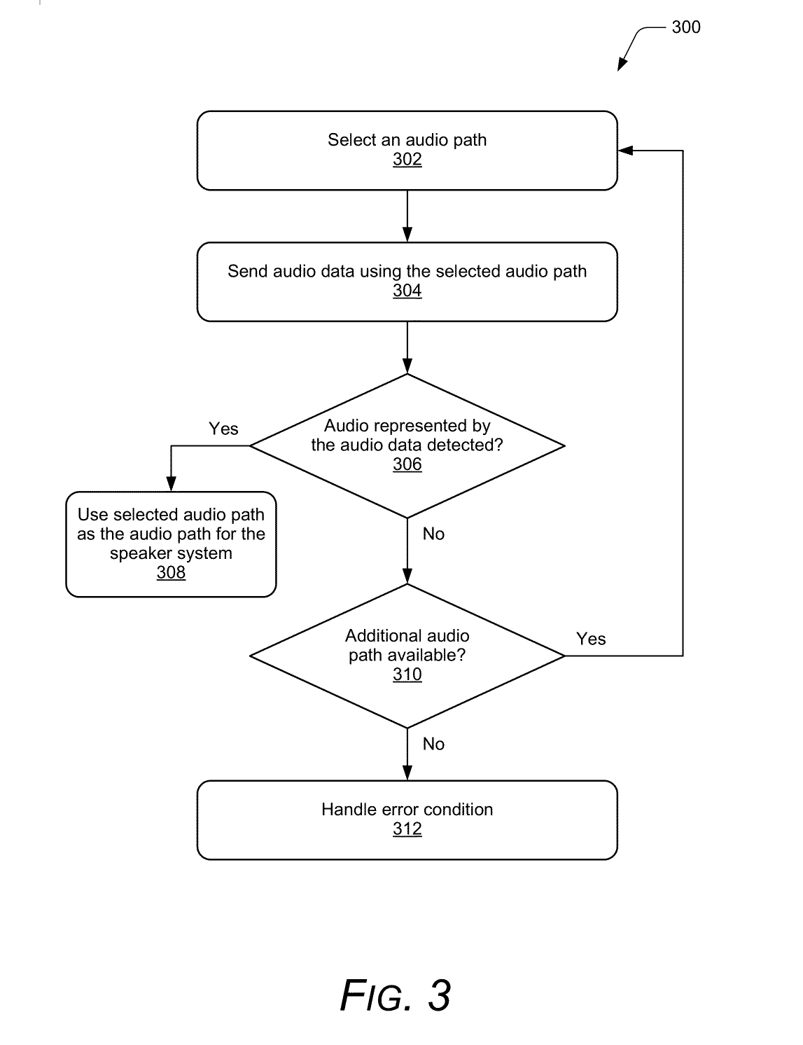

FIG. 3 illustrates an example process 300 for automatically determining an audio path for a peripheral speaker in accordance with one or more embodiments. Process 300 is carried out at least in part by a system such as audio-path-determination system 110 of FIGS. 1 and 2 and can be implemented in software, firmware, hardware, or combinations thereof. Process 300 is shown as a set of acts and is not limited to the order shown for performing the operations of the various acts. Process 300 is discussed with additional reference to FIGS. 1 and 2.

In process 300, an audio path is selected (act 302) by the audio-path-control module 222. The audio path refers to a wireless-communication configuration, setting, or technique used to communicate audio data wirelessly. In one or more embodiments, the audio path includes the particular wireless-communication technology used to communicate audio data to the speaker system 202. Different wireless-communication technologies can be used by the wireless device 102 and the speaker system 202 such as Bluetooth technology (e.g., in accordance with any of the Bluetooth specifications such as the Bluetooth 4.1 specification), Wi-Fi technology (e.g., in accordance with any of the Institute of Electrical and Electronics Engineers 802.11 standards such as the 802.11b standard, the 802.11g standard, 802.11n standard, etc.), and so forth. In such embodiments, automatic determination of the audio path includes automatically determining which wireless-communication technology to use to communicate audio data to the speaker system 202.

In one or more embodiments, the audio path includes the particular method of communication supported by the particular wireless-communication technology used to communicate audio data to the speaker system 202. Different wireless-communication technologies can support different methods of communication, these different methods having different settings, following different protocols, and so forth. In the case of Bluetooth technology, these methods can also be referred to as different Bluetooth profiles. For example, different methods can be used for communicating audio data using Bluetooth such as a voice-recognition method (e.g., using a voice-recognition channel), a synchronous-connection-oriented (“SCO”) link method using raw SCO, an SCO link method using virtual voice call over SCO, and a media method (e.g., using the Advanced Audio Distribution Profile). In such embodiments, automatic determination of the audio path includes automatically determining which method of communication supported by a particular wireless-communication technology to use to communicate audio data to the speaker system 202.

In one or more embodiments, the audio path includes the particular channel supported by the particular wireless-communication technology used to communicate audio data to the speaker system 202. Different wireless-communication technologies can use different channels. For example, different channels, each corresponding to a different frequency, can be used for communicating audio data using Bluetooth. In such embodiments, automatic determination of the audio path includes automatically determining which channel supported by a particular wireless-communication technology to use to communicate audio data to the speaker system 202.

The wireless-communication module 208 of the wireless device 102 supports one or more audio paths, and the wireless-communication module 212 of the speaker system 202 supports one or more audio paths. However, no communication channel between the wireless device 102 and the speaker system 202 that allows the wireless device 102 and the speaker system 202 to exchange indications of which one or more audio paths each supports need exist. Alternatively, if a communication channel between the wireless device 102 and the speaker system 202 that allows the wireless device 102 and the speaker system 202 to exchange indications of which one or more audio paths each supports, such communication channel need not be reliable. Regardless of such communication channel existence or reliability, process 300 allows the wireless device 102 to automatically determine which of the one or more audio paths supported by the wireless-communication module 208 (if any) is also supported by the wireless-communication module 212.

One of the audio paths supported by the wireless-communication module 208 is selected in act 302. The selection can be performed in any of a variety of manners, such as selection following a particular ordering (e.g., with audio paths that are more desired by the wireless device 102 being selected prior to audio paths that are less desired by the wireless device 102), selection based on random selection of an audio path supported by the wireless-communication module 208, selection using other rules or criteria, and so forth. In situations in which other techniques for identifying an audio path are used and are unable to reliably determine an audio path, audio paths attempted to be used by such other techniques can be excluded from the possible audio paths that are selected from in act 302. For example, if a communication channel between the wireless device 102 and the speaker system 202 that allows the wireless device 102 and the speaker system 202 to exchange indications that indicate a particular audio path is to be used, but the attempt to exchange such indications is unsuccessful, then that particular audio path can be removed as a possible audio path and is not selected in act 302.

Audio data are sent by the wireless device 102 using the selected audio path (act 304). The selected audio path is the audio path selected in act 302. The audio-path-control module 222 notifies the wireless-communication module 208 of the selected audio path, and the audio-playback module 204 notifies the wireless-communication module 208 of the audio data to be sent using the selected audio path. The audio data are representative of audio to be played back by the peripheral speaker 214, such as a particular tone, a spoken word or phrase, and so forth. The audio to be played back is known audio (audio that is known to or expected by the audio-path-determination system 110), so the audio-path-determination system 110 knows what audio the speaker system 202 will play back if the speaker system 202 receives the audio data.

A check is then made as to whether the audio represented by the audio data sent using the selected audio path is detected (act 306). The detection in act 306 is acoustic detection, which refers to the audio that was played back by the peripheral speaker 214 being received or sensed by the microphone 206. Control signals or other information is not passed between the wireless device 102 and the speaker system 202. Rather, the ability of the microphone 206 to sense the sound waves transmitted by the peripheral speaker 214 is used for the detection in act 306.

If the selected audio path used by the wireless-communication module 208 is supported by the wireless-communication module 212, then the speaker system 202 receives and understands the audio data sent by the wireless-communication module 208, and the peripheral speaker 214 plays back the audio represented by the received audio data. The audio played back by the peripheral speaker 214 is received by the microphone 206 and is analyzed by the audio-detection module 224 to determine if the audio received by the microphone 206 is the known audio represented by the audio data sent by the wireless-communication module 208. The audio is thus played back by a device (the peripheral speaker 214) separate from the wireless device 102 but is received by a microphone 206 of the wireless device 102. If the audio received by the microphone 206 is the known audio represented by the audio data sent by the wireless-communication module 208, then the audio represented by the audio data are detected in act 306.

However, if the selected audio path used by the wireless-communication module 208 is not supported by the wireless-communication module 212, then the speaker system 202 does not receive or does not understand the audio data sent by the wireless-communication module 208. In this situation the peripheral speaker 214 does not play back the audio represented by the sent audio data, the known audio represented by the audio data are not received by the microphone 206, and the audio represented by the audio data are not detected in act 306.

Process 300 proceeds based on whether the known audio represented by the audio data are detected in act 306. In response to the audio represented by the audio data being detected in act 306, the selected audio path is used as the audio path for the speaker system 202 (act 308). The audio-path-determination system 110 knows that the speaker system 202 receives audio data for playback using the selected audio path. The audio-path-control module 222 can thus notify the wireless-communication module 208 to use the selected path to send additional audio data desired to be played back by the audio-playback module 204 (e.g., music, movie audio, etc.) to the speaker system 202 for playback.

However, in response to the audio represented by the audio data not being detected in act 306, a check is made as to whether there are additional audio paths supported by the wireless-communication module 208 (act 310). The additional audio paths in act 310 refer to audio paths supported by the wireless-communication module 208 that have not yet been selected (as part of the current performance of process 300) and used to send audio data to the speaker system 202 in act 304. If there are such additional audio paths, then process 300 returns to act 302 where one of those additional audio paths is selected.

However, if there are no such additional audio paths, then the audio-path-determination system 110 handles the error condition (act 312). The error condition refers to the audio-path-determination system 110 not having been able to automatically determine an audio path that is supported by the speaker system 202. The error condition can be handled in act 312 by taking various remedial actions such as notifying a user of the wireless device 102 that an audio path could not be automatically determined, playing back audio data using a speaker of the wireless device 102 rather than the peripheral speaker 214, and so forth.

Process 300 can be performed at various times and in response to various events. In one or more embodiments, process 300 is performed in response to a user request for the wireless device 102 to communicate with the speaker system 202. Alternatively, process 300 can be performed at different times, such as in response to a request from a particular component or module of the wireless device 102 (e.g., an application running on the wireless device 102 that operates in a car or vehicle mode such as with fewer and larger buttons or options displayed for selection by the user).

Process 300 can also be performed at various times after an audio path has been selected in order to confirm or verify that audio data are being played back as desired using the selected audio path. In one or more embodiments, the audio-playback module 204 or wireless-communication module 208 provides an indication to the audio-detection module 224 of what audio data was sent to the speaker system 202 at a particular time. Audio-detection module 224 can then verify that the audio represented by that audio data are received by the microphone 206 analogous to the discussion above. For example, when the audio-playback module 204 is playing back a notification tone in order to notify a user of the wireless device 102 that a message has been received by the wireless device 102, audio-detection module 224 can verify that the notification tone that is expected to be played back by the peripheral speaker 214 is received by the microphone 206. If the notification tone that is expected to be played back is not received by the microphone 206, then process 300 can return to act 302 to select another audio path.

It should also be noted that in act 308 an indication of the selected path can optionally be saved for later use. The indication can be saved along with an associated environment or location for which the audio path was selected. For example, the indications can be saved in nonvolatile memory of the wireless device 102 so that the next time the wireless device 102 is at the associated environment or location the wireless device 102 can use the selected audio path as the audio path to communicate with the speaker system 202 or can use the selected audio path as the initial selected audio path in act 302 of process 300. The environment or location can be identified in different manners, such as being provided to the wireless device 102 from another component or device in the environment (e.g., another component or device in a vehicle), being determined by the wireless device 102 by analyzing its location (e.g., as determined by a global positioning system of the wireless device 102), being determined by the wireless device 102 analyzing the environment in which it is located (e.g., using object recognition and one or more images of the environment by a camera included in the wireless device 102), and so forth.

The techniques discussed herein support various different usage scenarios. For example, a user can be accustomed to having text messages received by his wireless device played back to him through the speakers of his car. If the user travels out of town and rents a car, then he can have the audio path for the rental car automatically selected by his wireless device so that the text messages he receives while in the rental car are played back to him through the speakers of the rental car. By way of another example, a user can be accustomed to being notified of new email messages received by his wireless device by an audible notification played back by a stereo system at his apartment. If the user travels out of town and stays at a hotel, then he can have the audio path for the hotel room automatically selected by his wireless device so that the audible notifications of new email messages are played back by a stereo system in his hotel room.

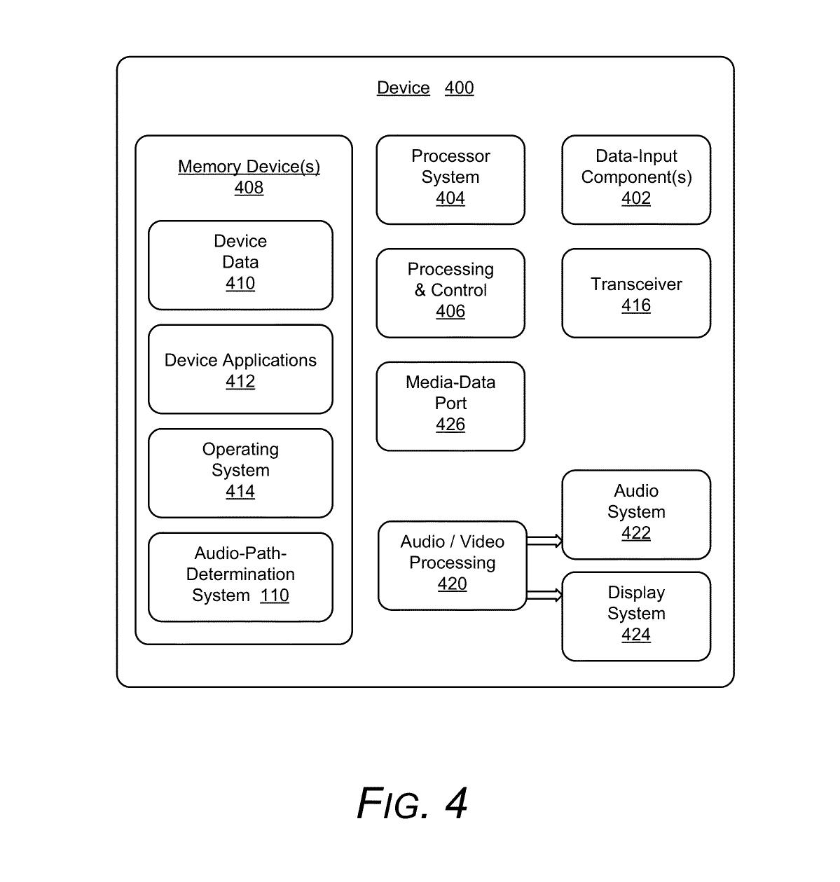

FIG. 4 illustrates various components of an example electronic device 400 that can be implemented as a device as described with reference to any of the previous FIGS. 1 through 3. The device may be implemented as any one or combination of a fixed or mobile device in any form of a consumer, computer, portable, user, communication, phone, navigation, gaming, messaging, Web browsing, paging, media playback, or other type of electronic device such as a wireless device 102 described above.

The electronic device 400 can include one or more data-input components 402 via which any type of data, media content, or inputs can be received such as user-selectable inputs, messages, music, television content, recorded video content, and any other type of audio, video, or image data received from any content or data source. The data-input components 402 may include various data-input ports such as universal serial bus ports, coaxial cable ports, and other serial or parallel connectors (including internal connectors) for flash memory, DVDs, compact discs, and the like. These data-input ports may be used to couple the electronic device to components, peripherals, or accessories such as keyboards, microphones, or cameras. The data-input components 402 may also include various other input components such as microphones, touch sensors, keyboards, and so forth.

The electronic device 400 of this example includes a processor system 404 (e.g., any of microprocessors, controllers, and the like) or a processor and memory system (e.g., implemented in a system on a chip) which processes computer-executable instructions to control operation of the device. A processing system may be implemented at least partially in hardware that can include components of an integrated circuit or on-chip system, an application-specific integrated circuit, a field-programmable gate array, a complex programmable logic device, and other implementations in silicon or other hardware. Alternatively or in addition, the electronic device can be implemented with any one or combination of software, hardware, firmware, or fixed-logic circuitry implemented in connection with processing and control circuits that are generally identified at 406. Although not shown, the electronic device can include a system bus or data transfer system that couples the various components within the device. A system bus can include any one or combination of different bus structures such as a memory bus or memory controller, a peripheral bus, a universal serial bus, or a processor or local bus that utilizes any of a variety of bus architectures.

The electronic device 400 also includes one or more memory devices 408 that enable data storage such as random-access memory, non-volatile memory (e.g., read-only memory, flash memory, erasable programmable read-only memory, electrically erasable programmable read-only memory, etc.), and a disk storage device. A memory device 408 provides data-storage mechanisms to store the device data 410, other types of information or data, and various device applications 412 (e.g., software applications). For example, an operating system 414 can be maintained as software instructions within a memory device and executed by the processor system 404.

In embodiments the electronic device 400 includes modules of an audio-path-determination system 110 described with reference to FIGS. 1 through 3. Although represented as a software implementation, the modules of the audio-path-determination system 110 may be implemented as any form of a control application, software application, signal-processing and control module, firmware that is installed on the device, a hardware implementation of the controller, and so on.

The electronic device 400 also includes a transceiver 416 that supports wireless communication with other devices or services allowing data and control information to be sent as well as received by the device 400. The wireless communication can be supported using any of a variety of different public or proprietary communication networks or protocols such as cellular networks (e.g., third generation networks, fourth generation networks such as Long Term Evolution networks), wireless local area networks such as Wi-Fi networks, and so forth. Transceiver 416 can include the wireless-communication module 208 described with reference to FIGS. 1 through 3.

The electronic device 400 can also include an audio or video processing system 420 that processes audio data or passes through the audio and video data to an audio system 422 or to a display system 424. The audio system or the display system may include any devices that process, display, or otherwise render audio, video, display, or image data. Display data and audio signals can be communicated to an audio component or to a display component via a radio-frequency link, S-video link, high-definition multimedia interface, composite video link, component video link, digital video interface, analog audio connection, or other similar communication link, such as media-data port 426. In implementations the audio system or the display system are external components to the electronic device. Alternatively or in addition, the display system can be an integrated component of the example electronic device, such as part of an integrated touch interface.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method in a wireless device of automatically selecting an audio path for communicating audio data from the wireless device to a speaker system including a peripheral speaker, the method comprising:
transmitting audio data representing known audio using a first audio path to the speaker system;
checking whether the known audio is acoustically detected at the wireless device;
in response to the known audio being acoustically detected at the wireless device after the audio data are transmitted using the first audio path, using the first audio path as the audio path for sending additional audio data to the speaker system; and
in response to the known audio not being acoustically detected at the wireless device after the audio data are transmitted using the first audio path:
transmitting the audio data using a second audio path;
checking whether the known audio is acoustically detected at the wireless device; and
in response to the known audio being acoustically detected at the wireless device after the audio data are transmitted using the second audio path, using the second audio path as the audio path for sending additional audio data to the speaker system.

2. The method of claim 1 wherein the peripheral speaker comprises a speaker in a vehicle.

3. The method of claim 1 wherein the wireless device comprises a wireless phone.

4. The method of claim 1 wherein the peripheral speaker is implemented in a housing separate from the wireless device.

5. The method of claim 1 wherein the audio is detected by a microphone implemented in the wireless device.

6. The method of claim 1 wherein the first audio path is selected from the group consisting of: Wi-Fi technology and Bluetooth technology.

7. The method of claim 1 wherein the first audio path and the second audio path are different methods of communication supported by Bluetooth technology.

8. The method of claim 1 wherein the audio path comprises wireless-communication methods or techniques used by the wireless device to wirelessly communicate audio data to the peripheral speaker for playback.

9. The method of claim 1 further comprising:
in response to the known audio not being acoustically detected at the wireless device after the audio data are transmitted using the second audio path:
transmitting the audio data using a third audio path;
checking whether the known audio is acoustically detected at the wireless device; and
in response to the known audio being acoustically detected at the wireless device, using the third audio path as the audio path for sending additional audio data to the speaker system.

10. A system implemented in a wireless device, the system comprising:
an audio-path-control module configured to select one of multiple audio paths supported by the wireless device;
a wireless-communication module configured to transmit to a speaker system including a peripheral speaker audio data representing known audio using the selected audio path; and
an audio-detection module configured to determine whether the known audio is acoustically detected at a microphone of the wireless device;
the wireless-communication module being further configured to use the selected audio path to send additional audio data to the speaker system in response to the known audio being acoustically detected at the microphone;
the audio-path-control module being further configured to, in response to the known audio not being acoustically detected at the microphone, continue to select ones of the multiple audio paths for the wireless-communication module to use to transmit the audio data to the speaker system until the known audio transmitted by the wireless-communication module using a selected one of the multiple audio paths is acoustically detected at the microphone.

11. The system of claim 10 wherein the audio-path-control module is further configured to take a remedial action in response to the audio data having been transmitted by the wireless-communication module using all of the multiple audio paths but the known audio not having been acoustically detected at the microphone.

12. The system of claim 10 wherein the multiple audio paths include one audio path using Wi-Fi technology and another audio path using Bluetooth technology.

13. The system of claim 10 wherein the multiple audio paths include different methods of communication supported by Bluetooth technology.

14. The system of claim 10 wherein each of the multiple audio paths comprises a wireless-communication method or technique used by the wireless device to wirelessly communicate audio data to the peripheral speaker for playback.

15. The system of claim 10 wherein the peripheral speaker comprises a vehicle speaker and the wireless device comprises a wireless phone.

16. A wireless device comprising:
a microphone;
a wireless-communication module configured to transmit to a speaker system particular audio data using a particular audio path;
an audio-detection module configured to determine whether known audio represented by the particular audio data are acoustically detected at the microphone; and
an audio-path-control module configured to select different ones of multiple audio paths supported by the wireless device for the wireless-communication module to use to transmit the particular audio data to the speaker system until the known audio represented by the particular audio data are acoustically detected at the microphone.

17. A wireless device of claim 16 wherein the multiple audio paths exclude one or more audio paths for which an attempt to exchange between the wireless device and the speaker system an indication of the one or more audio paths is unsuccessful.

18. A wireless device of claim 16 wherein the multiple audio paths include different methods of communication supported by Bluetooth technology.

19. A wireless device of claim 16 wherein each of the multiple audio paths comprises a wireless-communication method or technique used by the wireless device to wirelessly communicate audio data to the speaker system for playback.

20. A wireless device of claim 16 wherein the speaker system comprises a vehicle speaker and the wireless device comprises a wireless phone.
